(19) United States
(12) Patent Application Publication
(10) Pub. No.: US 2017/0322853 A1
(43) Pub. Date: Nov. 9, 2017

(54) METHOD OF MANAGING DATA OF FILE SYSTEM AND COMPUTING SYSTEM USING THE SAME

(71) Applicant: Ajou University Industry-Academic Cooperation Foundation, Suwon-si (KR)

(72) Inventors: Tae Shik SHON, Suwon-si (KR); Woo Yeon JO, Suwon-si (KR)

(73) Assignee: Ajou University Industry-Academic Cooperation Foundation, Suwon-si (KR)

(21) Appl. No.: 15/583,079

(22) Filed: May 1, 2017

(30) Foreign Application Priority Data
May 4, 2016 (KR) 10-2016-0055566

(51) Int. Cl. G06F 11/14; G06F 17/30

(52) U.S. Cl. CPC G06F 11/1469; G06F 17/30191; G06F 17/30091; G06F 17/30117; G06F 2201/84

(57) ABSTRACT

A method of managing data of a file system includes: obtaining information of an unallocated inode that is not currently used because a corresponding file has been deleted based on status of use of inodes stored in an inode bitmap and deletion information of the inodes stored in an inode table; retrieving a backup inode corresponding to the unallocated inode in a journal log area using the obtained information of the unallocated inode; and requesting selection of whether to permanently delete files corresponding to the retrieved backup inode.

### BACKGROUND

### 1. Field

One or more example embodiments relate to a method of managing data of a file system and a computing system using the method, and more particularly, to a method of managing data of a file system capable of outputting information of permanent deletion candidate files based on status of use of inodes and deletion information of the inodes, and a computing system using the method.

### 2. Description of the Related Art

A computing system has a file system to easily access to files stored in a hardware storage device and to manage the stored files.

That is, the file system represents a system that organizes rules for writing, reading, and managing data on the hardware storage device.

Since the file system is configured as a part of an Operating System (OS), the file system may have different forms according to a type of the OS. Examples of a Windows-based file system include File Allocation Table 16 (FAT16), FAT32, and an NT file system (NTFS), and examples of a Linux-based file system include Extended File System 2 (ext2), a Reiser file system (reiserFS), ext3, and ext4.

### SUMMARY

One or more example embodiments include a method of managing data of a file system capable of outputting information of permanent deletion candidate files based on status of use of inodes and deletion information of the inodes, and a computing system using the method.

Additional aspects will be set forth in part in the description which follows and, in part, will be apparent from the description, or may be learned by practice of the presented example embodiments.

According to an aspect of the inventive concept, a method of managing data of a file system performed by a computing system, the method comprising: obtaining information of an unallocated inode that is not currently used because a corresponding file has been deleted, based on status of use of inodes stored in an inode bitmap and deletion information of the inodes stored in an inode table; retrieving a backup inode corresponding to the unallocated inode in a journal log area, using the obtained information of the unallocated inode; and requesting selection of whether to permanently delete files corresponding to the retrieved backup inode.

In an embodiment, the status of use of the inodes is determined according to a bit value corresponding to each of the inodes stored in the inode bitmap.

In an embodiment, the deletion information of the inodes is determined according to values of bits indicating deletion time of each of the inodes stored in the inode table.

In an embodiment, the retrieving of the backup inode comprises retrieving the backup inode that is stored in the journal log area and is recoverable.

In an embodiment, the retrieving of the backup inode comprises retrieving the backup inode in which a value of a bit indicating a file size is not 0 and a value of a bit indicating deletion time is 0.

In an embodiment, the method of managing data of a file system further comprising: obtaining information about the files corresponding to the backup inode using a directory entry after the retrieving of the backup inode.

In an embodiment, the requesting of selection of whether to permanently delete files corresponding to the retrieved backup inode comprises determining priority order of the files and requesting the selection of whether to permanently delete the files, based on types of the files corresponding to the backup inode.

According to an aspect of the inventive concept, a computing system comprising: an application interface configured to request a file list including information of permanent deletion candidate files; and a file management device configured to obtain information of an unallocated inodes that is not currently used because a corresponding file has been deleted based on status of use of inodes stored in an inode bitmap of a file system and deletion information of the inodes stored in an inode table, retrieve a backup inode corresponding to the unallocated inode in a journal log area using the obtained information of the unallocated inode, and output the information of the permanent deletion candidate files including files corresponding to the retrieved backup inode, in response to the request.

In an embodiment, the status of use of the inodes is determined according to a bit value corresponding to each of the inodes of the inode bitmap.

In an embodiment, the deletion information of the inodes is determined according to values of bits indicating deletion time of each of the inodes stored in the inode table.

In an embodiment, the file managing device is configured to retrieve the backup inode that is stored in the journal log area and is recoverable.

In an embodiment, the file managing device is configured to retrieve the backup inode in which a value of a bit indicating a file size is not 0 and a value of a bit indicating deletion time is 0.

In an embodiment, the computing system further comprising: a processor configured to generate the file list based on the information of the permanent deletion candidate files output from the file managing device; and a display configured to display the generated file list.

In an embodiment, in the file list, file order or a method of displaying files varies according to determined priority order based on types of the files corresponding to the backup inode.

### BRIEF DESCRIPTION OF THE DRAWINGS

These and/or other aspects will become apparent and more readily appreciated from the following description of the example embodiments, taken in conjunction with the accompanying drawings in which:

FIG. 1 is a view of a structure of a file system according to an example embodiment of the inventive concept;

FIG. 2 is a flowchart of a method of managing data of a file system according to an example embodiment of the inventive concept;

FIG. 3 is a view of an inode bitmap included in the file system of FIG. 1;

FIG. 4 is a view of an inode table included in the file system of FIG. 1;

FIG. 5 is a view of a directory entry included in a directory and data blocks of the file system of FIG. 1;

FIG. 6 is a view of data pointing of an inode included in the inode table of FIG. 4; and

FIG. 7 is a block diagram of a computing system according to an example embodiment of the inventive concept.

### DETAILED DESCRIPTION

The inventive concept may be variously modified and have various example embodiments, so that specific example embodiments will be illustrated in the drawings and described in the detailed description. However, this does not limit the inventive concept to specific example embodiments, and it should be understood that the inventive concept covers all the modifications, equivalents and replacements included within the idea and technical scope of the inventive concept.

In describing the inventive concept, in the following description, a detailed explanation of known related technologies may be omitted to avoid unnecessarily obscuring the subject matter of the inventive concept. In addition, numeral figures (for example, 1, 2, and the like) used during describing the specification are just identification symbols for distinguishing one element from another element.

Further, in the specification, if it is described that one component is “connected” or “accesses” the other component, it is understood that the one component may be directly connected to or may directly access the other component but unless explicitly described to the contrary, another component may be “connected” or “access” between the components.

In addition, terms including “unit”, “er”, “or”, “module”, and the like disclosed in the specification mean a unit that processes at least one function or operation and this may be implemented by hardware or software such as a processor, a micro processor, a micro controller, a central processing unit (CPU), a graphics processing unit (GPU), an accelerated Processing unit (APU), a digital signal processor (DSP), an application specific integrated circuit (ASIC), and a field programmable gate array (FPGA) or a combination of hardware and software.

Moreover, it is intended to clarify that components in the specification are distinguished in terms of primary functions of the components. That is, two or more components to be described below may be provided to be combined to one component or one component may be provided to be divided into two or more components for each more subdivided function. In addition, each of the respective components to be described below may additionally perform some or all functions among functions which other components take charge of in addition to a primary function which each component takes charge of and some functions among the primary functions which the respective components take charge of are exclusively charged by other components to be performed, of course.

Hereinafter, example embodiments of the inventive concept will be described in detail.

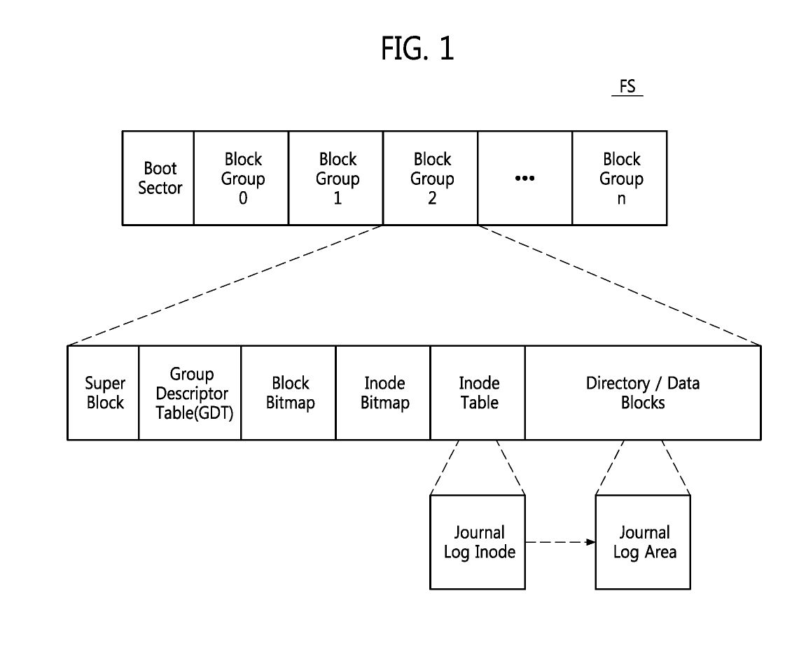

FIG. 1 is a view of a structure of a file system FS according to an example embodiment of the inventive concept.

Referring to FIG. 1, the file system FS of FIG. 1 is described based on an extended file system 4 (ext4) structure, but is not limited thereto.

The file system FS may include a boot sector and a plurality of block groups (block group 0 to block group n).

The boot sector includes information necessary for booting a computing system. Each of the block groups (block group 0 to block group n) indicates a unit for storing data in the file system FS. Each size of the block groups (block group 0 to block group n) may be specified when the file system FS is generated, and the specified size may be confirmed in a super block to be described later below.

Each of the block groups (block group 0 to block group n) may include a super block, a group descriptor table (GDT), a block bitmap, an inode bitmap, an inode table, and directory and data blocks.

All information of the file system FS is stored in the super block and the GDT.

The super block is a block representing the block groups (block group 0 to block group n) of the file system FS, and main setting information of the file system FS is recorded therein. That is, the super block is the most basic metadata when analyzing a structure of the file system FS.

Main data stored in the super block includes the number of the block groups (block group 0 to block group n), the total number of blocks, sizes of the data blocks, the number of blocks in each of the block groups (block group 0 to block group n), the number of inodes in each of the block groups (block group 0 to block group n), and the number of unallocated inodes.

The GDT starts from the next block of the super block and includes detailed information about the block groups (block group 0 to block group n).

Main data stored in the GDT includes an offset of the block bitmap, an offset of the inode bitmap, and an offset of the inode table.

The block bitmap starts from the next block of the GDT, but a location of the block bitmap is not fixed because a size of the GDT is not constant.

The block bitmap expresses status of use of each block as a bit value. For example, the status of use may be represented as ‘1’ if a corresponding block is in use or ‘0’ if the corresponding block is not in use.

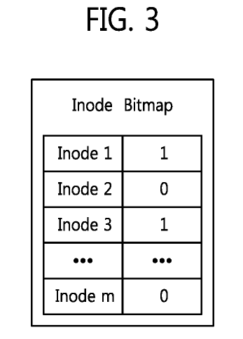

The inode bitmap expresses status of use of all inodes managed by a corresponding block group by a bit value. A structure of the inode bitmap will be described in detail with reference to FIG. 3.

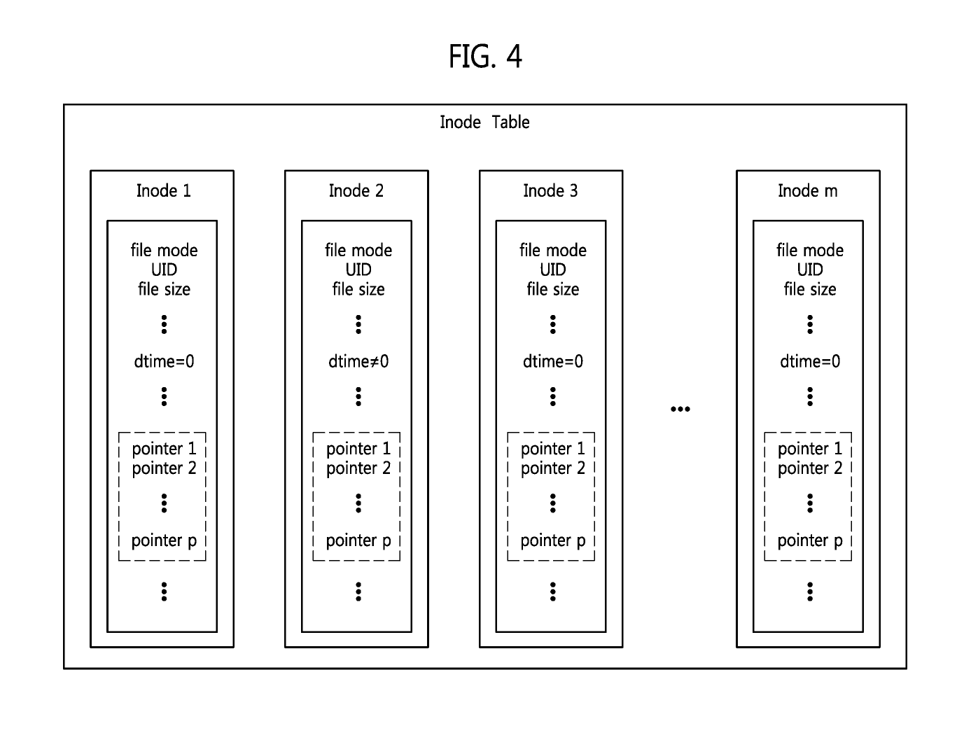

The inode table may include a plurality of inodes, and a structure of the inode table is described in detail with reference to FIG. 4.

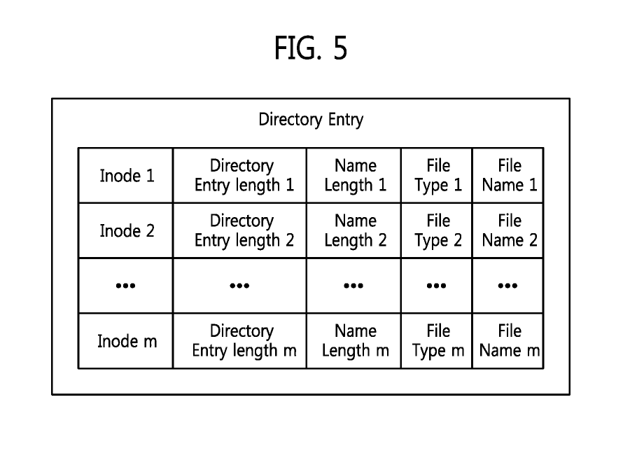

The directory and data blocks include directories that create and store access paths to files and data blocks that store data of the files. In particular, the directory and data blocks include a directory entry including a list of directories, and a structure of the directory entry will be described in detail with reference to FIG. 5.

The directory and data blocks may include a journal log area.

The journal log area is an area where data is backed up in the file system FS having a data backup function. Reliability of the file system FS is improved by writing update contents of data in the journal log area before updating the data in the file system FS. Therefore, even if unexpected system shutdown or process collision occurs during instruction execution, the instruction execution may be normally resumed by overwrite backup data in the journal log area.

A location of the journal log area may be determined by a journal log inode pointing to the journal log area among the plurality of inodes included in the inode table.

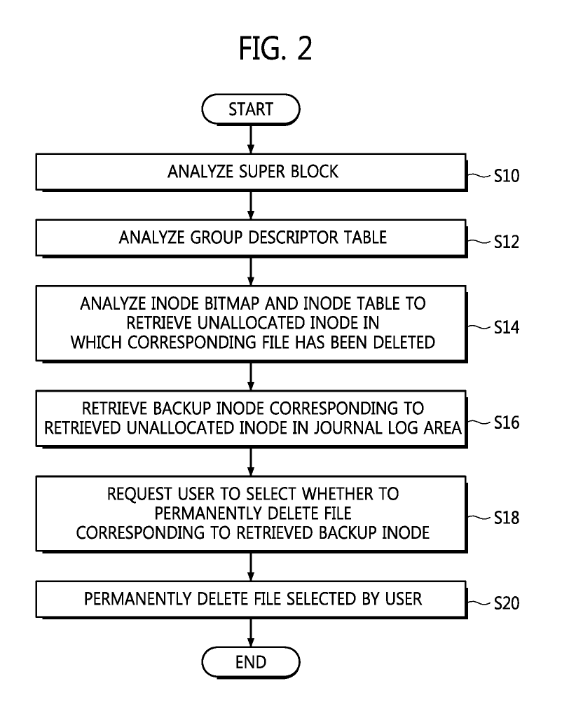

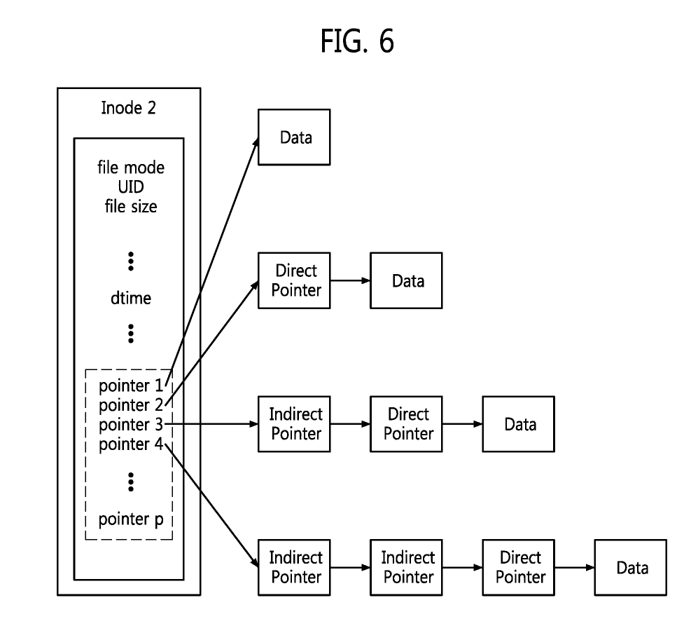

FIG. 2 is a flowchart of a method of managing data of a file system according to an example embodiment of the inventive concept. FIG. 3 is a view of the inode bitmap included in the file system of FIG. 1. FIG. 4 is a view of the inode table included in the file system of FIG. 1. FIG. 5 is a view of the directory entry included in the directory and data blocks of the file system of FIG. 1. FIG. 6 is a view of data pointing of an inode included in the inode table of FIG. 4.

Referring to FIGS. 1 and 2, in operation S10, the computing system including the file system FS may analyze the super block of the file system FS first according to a request of a file list including information of permanent deletion candidate files that are candidates of permanent deletion.

As a result of the analysis of the super block in operation S10, information on the number of the block groups (block group 0 to block group n), the total number of blocks, the sizes of the data blocks, the number of blocks in each of the block groups (block group 0 to block group n), the number of inodes in each of the block groups (block group 0 to block group n), the number of unallocated inodes, and the like may be obtained.

Next, in operation S12, the computing system may analyze the GDT of the file system FS.

As a result of the analysis of the GDT in operation S12, information on the offset of the block bitmap, the offset of the inode bitmap, and the offset of the inode table may be obtained.

Information on a location of the inode bitmap may be obtained based on the offset of the inode bitmap and the sizes of the data blocks obtained in operations S10 and S12, and information on a location of the inode table may be obtained based on the offset of the inode table and the sizes of the data blocks.

In operations S14, when the locations of the inode bitmap and the inode table are confirmed, the computing system may analyze the inode bitmap and the inode table to retrieve unallocated inodes in which corresponding files are deleted.

In operation S14, the unallocated inodes in which corresponding files are deleted may be determined based on status of use of inodes stored in the inode bitmap and deletion information of inodes stored in the inode table.

Referring to FIGS. 2 and 3, the inode bitmap displays status of use of each of inodes (Inode 1 to Inode m) as a bit value. For example, inodes being used, that is, allocated inodes (for example, Inode 1 and Inode 3) have a bit value of ‘1’, and unused inodes or unallocated inodes (e.g., Inode 2 and Inode m) have a bit value of ‘0’.

Referring to FIGS. 2 and 4, the inode table includes the plurality of inodes (Inode 1 to Inode m), and each of the inodes (Inode 1 to Inode m) may include a file mode, a user ID (UID), a file size, a file deletion time (dtime), and a plurality of pointers (pointer 1 to pointer p).

Here, based on a bit value of the file deletion time (dtime) included in each of the plurality of inodes (Inode 1 to Inode m), it can be determined whether or not a corresponding file of each inode has been deleted. For example, an inode (e.g., Inode 2) in which a corresponding file has been deleted has a bit value related to the file deletion time (dtime) that is not ‘0’, and inodes (e.g., Inode 1, Inode 3, and Inode m) in which corresponding files are not deleted have a bit value of ‘0’ related to the file deletion time (dtime).

According to an example embodiment, among inodes (e.g., Inode 2 and Inode m) having a bit value of the inode bitmap of ‘0’, an inode having a bit value related to the file deletion time that is not ‘0’ in the inode table is retrieved as an unallocated inode in operation S14.

According to an example embodiment, any one of the plurality of inodes (Inode 1 to Inode m) may be implemented as the journal log inode (see FIG. 1) that points to the journal log area.

Referring again to FIG. 2, in operation S16, the computing system may retrieve a backup inode corresponding to the unallocated inode retrieved in operation S14 in the journal log area of the file system FS.

According to an example embodiment, the computing system may retrieve whether or not a backup inode having inode information (for example, an inode number) matching information (for example, an inode number) of the unallocated inode retrieved in operation S14 exists in the journal log area.

According to another example embodiment, the computing system may retrieve only a backup inode that is recoverable among backup inodes corresponding to the unallocated inode retrieved in operation S14, in the journal log area of the file system FS.

Here, the recoverable backup inode may refer to a backup inode that includes file data and is not deleted from the journal log area. The backup inode may be a backup inode in which a bit value related to a file size is not ‘0’ (that is, file data exists) and a bit value related to the file deletion time (dtime) is ‘0’ (that is, file data is not deleted).

Referring to FIGS. 1, 2, and 5, the computing system may obtain file information corresponding to the backup inode retrieved in operation S16. According to an example embodiment, the computing system may obtain file information corresponding to the backup inode with reference to the directory entry included in the directory and data blocks of the file system FS.

The directory entry may include information on lengths of directory entries (directory entry length 1 to directory entry length m), lengths of file names (name length 1 to name length m), file types (file type 1 to file type m), file names (file name 1 to file name m), and the like for each of the inodes (Inode 1 to Inode m).

Referring again to FIG. 2, in operation S18, the computing system may request a user to select whether to permanently delete files corresponding to the backup inode retrieved in operation S16.

According to an example embodiment, in operation S18, the computing system may generate a file list including information on the permanent deletion candidate files based on the file information obtained from the directory entry, and may provide the file list to a user.

According to another example embodiment, the file system may prioritize the files corresponding to the backup inode according to a file type (a file extension, a file format (e.g., an image or a text), etc.) and request a user to select whether to permanently delete the files corresponding to the backup inode.

An order of files in the file list of the permanent deletion candidate files provided to a user may vary according to the priority order. For example, the file system may set a high priority for an image file (a file having an extension of jpg, gif, or the like) that can significantly affect privacy of a user and place the image file at the top of the file list of permanent deletion candidate files or highlight the image file in the file list to provide a user with the highlighted image file.

Referring again to FIG. 2, in operation S20, the computing system may permanently delete a file selected by a user.

Referring to FIGS. 2 and 6, when performing the permanent deletion in operation S20, the computing system, with reference to an inode (e.g., Inode 2) of the file selected by a user, may track data corresponding to a depth of tree of a direct block pointer (e.g., pointer 1), a single indirect block pointer (e.g., pointer 2), a double indirect block pointer (e.g., pointer 3), and a triple indirect block pointer (e.g., pointer 4) of the corresponding inode to permanently delete the corresponding data.

According to an example embodiment, when data is permanently deleted, the corresponding data may be overwritten with ‘0’, ‘1’, or a random value, and the number of times of overwriting the data may be set to plural.

Here, the number of times of overwriting the data may vary depending on a depth of tree of a backup inode to be permanently deleted. For example, the greater a depth of tree of a backup inode, the greater the number of times of overwriting data.

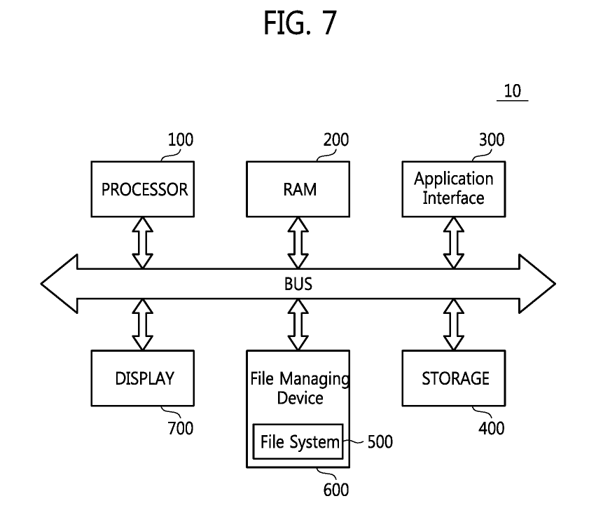

FIG. 7 is a block diagram of the computing system 10 according to an example embodiment of the inventive concept.

Referring to FIGS. 1 to 7, the computing system 10 may include a processor 100, random-access memory (RAM) 200, an application interface 300, a storage 400, a file managing device 500, and a display 700 that are connected to a bus.

A configuration of the computing system 10 of FIG. 7 is only an example embodiment, and the computing system 10 may be configured to exclude or add some components according to an example embodiment.

The processor 100 may process a general operation of the computing system 10 and generate input/output instructions for inputting/outputting data to/from the storage 400.

The RAM 200 may store data necessary for an operation of the processor 100, and the processor 100 may calculate, or process data stored in the RAM 200.

The application interface 300 may forward a request generated by a user or an application to the processor 100, and may receive and output a result processed by the processor 100.

The storage device 400 stores data and the data stored in the storage 400 may be input/output in response to the input/output instructions of the processor 100.

The file managing device 600 may use at least one file system 500. Data input and output to and from the storage 400 may be accessed or managed by the file system 500. According to an example embodiment, the file system 500 of FIG. 7 may be implemented in the same manner as the file system FS of FIG. 1. According to another example embodiment, the file system 500 may be implemented in various forms such as an Advanced Disc Filing System (AdvFS), a Be File System (BFS), a Btrfs, a CrossDOS, a Disk Filing System (DFS), Episode, an Encrypting File System (EFS), an Extended File Allocation Table (exFAT), an Extended File System (ext), ext2, ext3, Files-11, a Hierarchical File System (HFS), HFS Plus, a High Performance File System, IBM's General Parallel File System (GPFS), a Journal File System (JFS), a Macintosh File System, MINIX, a NetWare File System, a Log-structured File System (NILFS), a Novell Storage Service, a New Technology File System (NTFS), a Quick File System (QFS), QNX4FS, a Reiser File System (ReiserFS), SpadFS, an Unsorted Block Image File System (UBIFS), a Unix file system, a Veritas File System (VxFS), a (Virtual File Allocation Table (VFAT), a Write Anywhere File Layout (WAFL), an Exemplary Extended File System (XFS), Xsan, and a Zettabyte File System (ZFS).

The display 700 may display the result processed by the processor 100.

According to an example embodiment, when a request for a file list including information of permanent deletion candidate files is input through the application interface 300, the processor 100 may obtain file information corresponding to the request from the file system 500 of the file managing device 600 according to operations S10 to S18 of FIG. 2, and may create a file list based on the obtained file information to provide the application interface 300 with the file list.

A user selects a file to be permanently deleted through the application interface 300 according to the provided file list and the processor 100 delivers an instruction to the file system 500 of the file managing device 600 so that the selected file is deleted. As a result, the file may be permanently deleted.

A method and a device according to an example embodiment of the inventive concept may improve a protection strength of personal information by providing a user with information about a file, which is remaining in a storage device even after a deletion process, so that the file may be permanently deleted.

In addition, priority order is set according to types of permanent deletion candidate files so that a user may efficiently select a file to be permanently deleted by changing an order of the files or a method of displaying the files in a file list provided to the user.

It should be understood that example embodiments described herein should be considered in a descriptive sense only and not for purposes of limitation. Descriptions of features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from the spirit and scope of the disclosure as defined by the following claims.

What is claimed is:

1. A method of managing data of a file system performed by a computing system, the method comprising:
obtaining information of an unallocated inode that is not currently used because a corresponding file has been deleted, based on status of use of inodes stored in an inode bitmap and deletion information of the inodes stored in an inode table;
retrieving a backup inode corresponding to the unallocated inode in a journal log area, using the obtained information of the unallocated inode; and
requesting selection of whether to permanently delete files corresponding to the retrieved backup inode.

2. The method of claim 1, wherein
the status of use of the inodes is determined according to a bit value corresponding to each of the inodes stored in the inode bitmap.

3. The method of claim 1, wherein
the deletion information of the inodes is determined according to values of bits indicating deletion time of each of the inodes stored in the inode table.

4. The method of claim 1, wherein
the retrieving of the backup inode comprises retrieving the backup inode that is stored in the journal log area and is recoverable.

5. The method of claim 4, wherein
the retrieving of the backup inode comprises retrieving the backup inode in which a value of a bit indicating a file size is not 0 and a value of a bit indicating deletion time is 0.

6. The method of claim 1, further comprising:
obtaining information about the files corresponding to the backup inode using a directory entry after the retrieving of the backup inode.

7. The method of claim 6, wherein
the requesting of selection of whether to permanently delete files corresponding to the retrieved backup inode comprises determining priority order of the files and requesting the selection of whether to permanently delete the files, based on types of the files corresponding to the backup inode.

8. A computing system comprising:
an application interface configured to request a file list including information of permanent deletion candidate files; and
a file management device configured to obtain information of an unallocated inodes that is not currently used because a corresponding file has been deleted based on status of use of inodes stored in an inode bitmap of a file system and deletion information of the inodes stored in an inode table, retrieve a backup inode corresponding to the unallocated inode in a journal log area using the obtained information of the unallocated inode, and output the information of the permanent deletion candidate files including files corresponding to the retrieved backup inode, in response to the request.

9. The computing system of claim 8, wherein
the status of use of the inodes is determined according to a bit value corresponding to each of the inodes of the inode bitmap.

10. The computing system of claim 8, wherein
the deletion information of the inodes is determined according to values of bits indicating deletion time of each of the inodes stored in the inode table.

11. The computing system of claim 8, wherein
the file managing device is configured to retrieve the backup inode that is stored in the journal log area and is recoverable.

12. The computing system of claim 11, wherein
the file managing device is configured to retrieve the backup inode in which a value of a bit indicating a file size is not 0 and a value of a bit indicating deletion time is 0.

13. The computing system of claim 8, further comprising:
a processor configured to generate the file list based on the information of the permanent deletion candidate files output from the file managing device; and
a display configured to display the generated file list.

14. The computing system of claim 13, wherein,
in the file list, file order or a method of displaying files varies according to determined priority order based on types of the files corresponding to the backup inode.
